(19) United States
(12) Patent Application Publication
(10) Pub. No.: US 2015/0000269 A1
(43) Pub. Date: Jan. 1, 2015

(54) TURBO-COMPOUND APPARATUS HAVING VARIABLE GEOMETRY TURBOCHARGER TURBINE AND ENGINE SYSTEM HAVING THE SAME

(71) Applicant: Tsinghua University, Beijing (CN)

(72) Inventors: Weilin Zhuge, Beijing (CN); Yangjun Zhang, Beijing (CN); Rongchao Zhao, Beijing (CN); Junyue Zhang, Beijing (CN); Weidong Xing, Beijing (CN)

(21) Appl. No.: 14/378,289

(22) PCT Filed: Feb. 8, 2013
(86) PCT No.: PCT/CN2013/071578

§ 371 Date: Aug. 12, 2014

(30) Foreign Application Priority Data
Feb. 13, 2012 (CN) 201210032015.7

(51) Int. Cl. F02B 37/00; F02B 37/22; F02B 29/04

(52) U.S. Cl. CPC F02B 37/004; F02B 29/04; F02B 37/22
USPC 60/599; 60/602

(57) ABSTRACT

A turbo-compound apparatus having a variable geometry turbocharger turbine and an engine system having the same are provided. The turbo-compound apparatus includes a variable geometry turbocharger turbine connected to an exhaust manifold of the engine and having an adjustable mechanism to distribute the exhaust energy between two turbines; a power turbine fitted downstream of the variable geometry turbocharger turbine and driven by exhaust gas passing through the variable geometry turbocharger turbine, an output end of the power turbine being adapted to connect with a crankshaft of the engine to transfer mechanical work output from the power turbine to the crankshaft; and an actuator configured to control the adjustable mechanism according to actual engine operation conditions to regulate the exhaust energy distribution between the variable geometry turbocharger turbine and the power turbine.

### FIELD

Embodiments of the present invention generally relate to an exhaust energy recovery of an internal combustion engine, and more particularly, to a turbo-compound apparatus having a variable geometry turbocharger turbine and an engine system having the same.

### BACKGROUND

In the internal combustion engine area, the turbo-compounding is a technology to recover the waste heat from the exhaust of the internal combustion engine and to improve the efficiency of the internal combustion engine. In a turbo-compound engine, the turbine system includes a turbocharger turbine and a power turbine. The turbocharger turbine is used to drive the compressor to increase the air density and to improve the power density of the engine. The power turbine is used to recover and convert the exhaust energy into the mechanical work so as to improve the total power of the engine.

In the conventional turbo-compound engine, a fixed geometry turbocharger turbine is adopted to cooperate with the power turbine. When the engine operates at high-speed conditions, the exhaust energy is sufficient and the power turbine recovers the waste heat from the exhaust. Therefore, the fuel economy performance of the engine can be improved effectively. When the engine operates at low-speed conditions, the exhaust energy is relatively less and the energy available for the turbocharger turbine may be reduced due to the power turbine. Consequently, the pressure ratio will decrease, leading to lower torque output at low speed conditions. This means that the mechanical work recovered by the power turbine may not compensate the power loss of the engine due to the decrease of the pressure ratio. Thus, it is difficult for the turbo-compound engine with a fixed geometry turbocharger turbine to achieve good performance both at high-speed and low-speed conditions. Moreover, the performance of the engine may even become worse at the low-speed condition.

### SUMMARY

Embodiments of the present invention seek to solve at least one of the problems existing in the related art to at least some extent.

Accordingly, an object of the present invention is to provide a turbo-compound apparatus.

Another object of the present invention is to provide an engine system having the above turbo-compound apparatus, which can make use of the exhaust energy effectively to improve the power performance and the torque output of an engine.

Embodiments of a first aspect of the present invention provide a turbo-compound apparatus applied to recover waste heat from the engine exhaust. The turbo-compound apparatus includes a variable geometry turbocharger turbine connected to an exhaust manifold of the engine and having an adjustable mechanism to distribute the exhaust energy between two turbines; a power turbine fitted downstream of the variable geometry turbocharger turbine and driven by exhaust gas passing through the variable geometry turbocharger turbine, an output end of the power turbine being adapted to connect with a crankshaft of the engine to transfer mechanical work output from the power turbine to the crankshaft; and an actuator configured to control the adjustable mechanism according to actual engine operation conditions to regulate the exhaust energy distribution between the variable geometry turbocharger turbine and the power turbine.

The turbo-compound apparatus according to embodiments of the present invention further has the following additional technical features.

In some embodiments, the adjustable mechanism includes a guiding device disposed upstream a blade of the variable geometry turbocharger turbine and provided with a variable opening degree, and the guiding device is configured so as to continuously change the opening degree according to the actual engine operation condition to regulate the exhaust energy distribution between the variable geometry turbocharger turbine and the power turbine.

Embodiments of a second aspect of the present invention provide an engine system, including an engine including a crankshaft, an intake manifold and an exhaust manifold for discharging an exhaust gas; a turbo-compound apparatus according to embodiments of the first aspect of the present invention, the variable geometry turbocharger turbine being disposed downstream of the exhaust manifold of the engine to receive the exhaust gas discharged from the engine; a compressor connected with the variable geometry turbocharger turbine and driven by the variable geometry turbocharger turbine to compress air entering into the compressor; and an intercooler connected between the compressor and a cylinder of the engine to cool down the compressed air and deliver the cooled air to the engine cylinder.

As for the engine system according to embodiments of the present invention, it is equipped with a variable geometry turbocharger turbine and a power turbine. It is possible to improve torque and reduce emission at engine low speed operation condition by distributing more exhaust energy to the turbocharger turbine. At engine high-speed conditions, it is possible to improve the fuel economy by distributing more exhaust energy to the power. The systems can make full use of the engine exhaust energy at all operation conditions, thus improving the power performance and torque output of the engine, improving the fuel economy, reducing the exhaust gas emission and facilitating an environmental protection. Meanwhile, drivability and passing capacity of a vehicle are also improved and a better practicability is provided.

In some embodiments, the compressor is connected with the variable geometry turbocharger turbine coaxially.

In some embodiments, the engine system further includes a hydraulic coupler having an input shaft connected with the power turbine and an output shaft connected with the crankshaft of the engine so as to transfer the mechanical work of the power turbine to the crankshaft.

In some embodiments, the engine system further includes a first transmission assembly connected between the input shaft of the hydraulic coupler and the power turbine.

In some embodiments, the engine system further includes a second transmission assembly connected between the output shaft of the hydraulic coupler and the crankshaft.

In some embodiments, the first transmission assembly and the second transmission assembly are one-stage gear transmission assemblies respectively.

As for the engine system according to embodiments of the present invention, it is possible to adjust the exhaust energy distribution between the turbocharger turbine and the power turbine according to the engine actual operation condition, such that the torque output and the power performance of the engine are improved, the fuel consumption of the engine is reduced. Meanwhile, the harmful gas emission is reduced to protect the environment, and the exhaust energy is made full use of, thus greatly improving the performance of the engine at all the operation conditions.

Additional aspects and advantages of embodiments of present invention will be given in part in the following descriptions, become apparent in part from the following descriptions, or be learned from the practice of the embodiments of the present invention.

### BRIEF DESCRIPTION OF THE DRAWINGS

These and other aspects and advantages of embodiments of the present invention will become apparent and more readily appreciated from the following descriptions made with reference to the accompanying drawings, in which:

FIG. 1 is a schematic view of an engine system according to an embodiment of the present invention;

FIG. 2 is a schematic partial view of an adjustable mechanism at engine high-speed condition according to an embodiment of the present invention;

FIG. 3 is a schematic partial view of an adjustable mechanism at engine low-speed condition according to an embodiment of the present invention;

FIG. 4 is a comparison diagram of a brake specific fuel consumption of an engine system according to an embodiment of the present invention and an engine system having a conventional VGT and a conventional turbo-compound system in all operation conditions; and

FIG. 5 is a comparison diagram of a torque output of an engine system according to an embodiment of the present invention and an engine system having a conventional VGT and a conventional turbo-compound system at all operation conditions.

### DETAILED DESCRIPTION

Reference will be made in detail to embodiments of the present invention. The same or similar elements and the elements having same or similar functions are denoted by like reference numerals throughout the descriptions. The embodiments described herein with reference to drawings are explanatory, illustrative, and used to generally understand the present invention. The embodiments shall not be construed to limit the present invention.

In the specification, unless specified or limited otherwise, relative terms such as “central”, “upper”, “lower”, “front”, “rear”, “left”, “right”, “vertical”, “horizontal”, “top”, “bottom”, “inner”, “outer” as well as derivative thereof should be construed to refer to the orientation as then described or as shown in the drawings under discussion. These relative terms are for convenience of description and do not require that the present invention be constructed or operated in a particular orientation.

In addition, terms such as “first” and “second” are used herein for purposes of description and are not intended to indicate or imply relative importance or significance. Thus, features limited by “first” and “second” are intended to indicate or imply including one or more than one these features. In the description of the present invention, “a plurality of” relates to two or more than two.

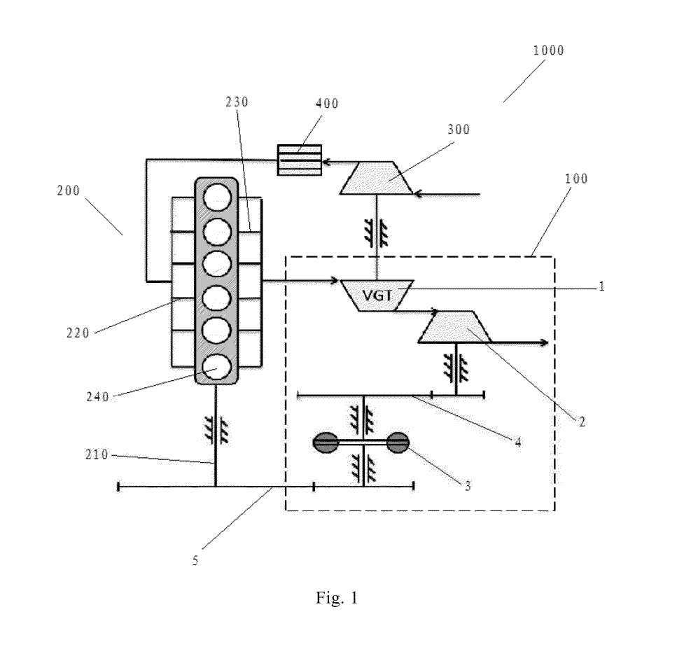

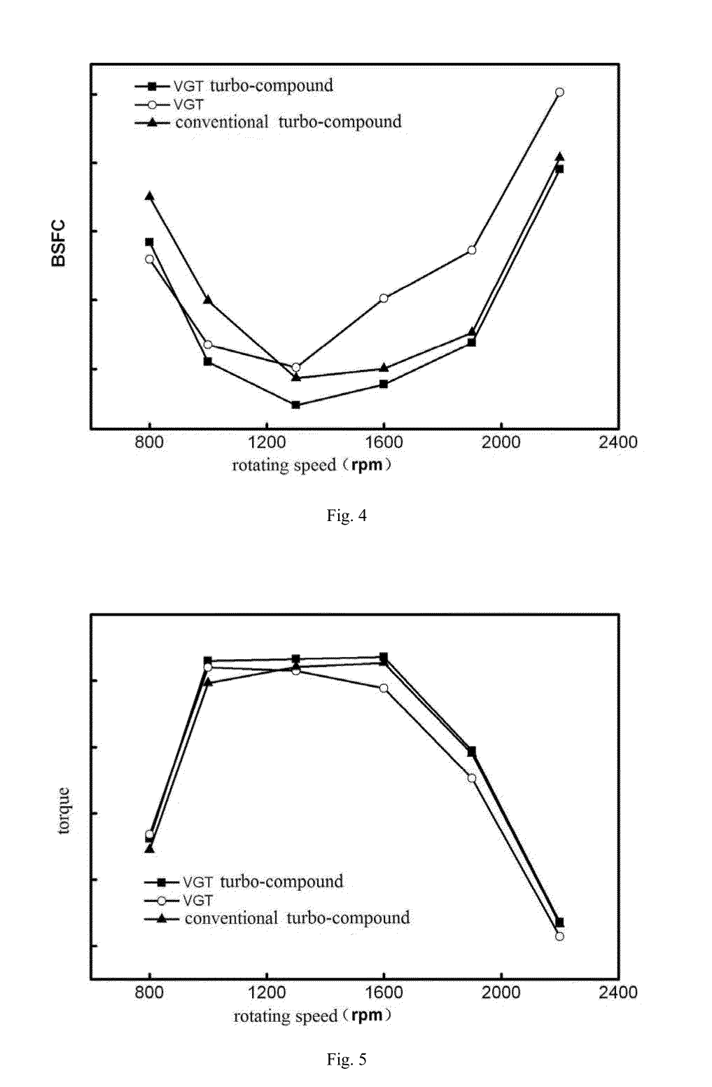

First, an engine system 1000 according to a second aspect of the present invention will be described in the following with reference to FIGS. 1-5.

The engine system 1000 according to embodiments of the present invention includes an engine 200, a turbo-compound apparatus 100, a compressor 300 and an intercooler 400. The engine 200 includes a crankshaft 210, an intake manifold 220 and an exhaust manifold 230. The crankshaft 210 is configured to output power of the engine 200, and the intake manifold 220 is configured to provide a plurality of cylinders 240 with air and the exhaust manifold 230 is configured to discharge exhaust gas from cylinders 240, as shown in FIG. 1.

The turbo-compound apparatus 100 according to the first aspect of the present invention will be described in the following with reference to FIGS. 1-5, in which the turbo-compound apparatus 100 is disposed downstream of the exhaust manifold 230 of the engine 200 to receive the exhaust energy discharged from the engine 200, i.e., energy in the exhaust gas.

The turbo-compound apparatus 100 according to embodiments of the present invention may include a variable geometry turbocharger turbine 1, a power turbine 2 and an actuator, in which the variable geometry turbocharger turbine 1 is connected with the exhaust manifold 230 of the engine 200. For example, in an embodiment, the variable geometry turbocharger turbine 1 is fitted downstream of the exhaust manifold 230 of the engine 200 to receive the exhaust gas discharged from the engine 200. The variable geometry turbocharger turbine 1 has an adjustable mechanism 11 to regulate the exhaust energy distribution, as shown in FIGS. 1-3, in which a VGT (variable geometry turbocharger turbine) shown in FIG. 1 refers to the variable geometry turbocharger turbine 1. Here, it should be noted that, the above and following descriptions of the variable geometry turbocharger turbine 1 are known to those skilled in the area and the present invention provides a simple illustration to only one type of the variable geometry turbine 1 as an example. In addition, it can be understood by those skilled in the area that, other types of variable geometry turbocharger turbines 1 are also applicable for the turbo-compound apparatus 100.

The power turbine 2 is fitted downstream of the variable geometry turbocharger turbine 1 and driven by the exhaust gas passing through the variable geometry turbocharger turbine 1, in which an output end of the power turbine 2 is connected with the crankshaft 210 of the engine 200 to transfer mechanical work output by the power turbine 2 to the crankshaft 210. The actuator is configured to control the adjustable mechanism 11 to operate according to the actual operation condition of the engine 200 to regulate the exhaust energy distribution between the variable geometry turbocharger turbine 1 and the power turbine 2. In other words, at different operation conditions of the engine 200, the actuator controls the adjustable mechanism 11 to perform a corresponding adjustment to improve power and torque output of the power turbine 2 or the variable geometry turbocharger turbine 1, such that the exhaust energy in the exhaust gas discharged from engine 200 at different operation conditions can be used more sufficiently and reasonably.

Alternatively, the adjustable mechanism 11 includes a guiding device 111 which is fitted upstream to blades of the variable geometry turbocharger turbine 1 and provided with a variable opening degree. The guiding device 111 is configured so as to continuously change the opening degree according to the actual operation condition of the engine 200 to regulate the exhaust energy distribution between the variable geometry turbocharger turbine 1 and the power turbine 2. In other words, the opening degree of the guiding device 111 is predetermined according to the corresponding operation condition of the engine 200.

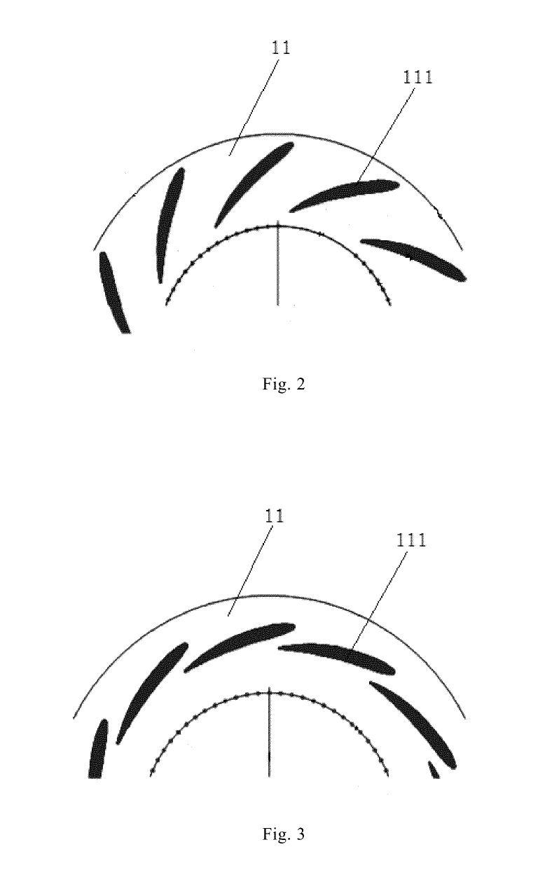

For example, when the engine 200 works at a high-speed condition, the actuator controls the adjustable mechanism 11 to enlarge the opening degree of the guiding device 111, such that the effective area which the exhaust gas passes through is increased, and the expansion ratio of the variable geometry turbocharger turbine 1 is reduced so as to distribute a larger proportion of the exhaust energy to drive the power turbine 2, thus effectively enhancing power output of the power turbine 2, improving fuel economy of the engine 200, as shown in FIGS. 2, 4 and 5. BSFC shown in FIG. 5 is short for Brake Specific Fuel Consumption, i.e., an effective specific fuel consumption which is a standard to measure the fuel economy of a vehicle in the area.

For example, when the engine 200 works at a low-speed condition, the actuator controls the adjustable mechanism 11 to reduce the opening degree of the guiding device 111, such that the effective area which the exhaust gas passes through is reduced, and the expansion ratio and power output of the variable geometry turbocharger turbine 1 are increased and the output power of the power turbine 2 is reduced, thus improving the torque output and the power performance of the engine 200 at the low-speed condition and improving drivability of the vehicle, as shown in FIGS. 3-5.

In other words, at different operation conditions of the engine 200, the guiding device 111 has one optimal opening degree to obtain optimal distribution of exhaust energy between the variable geometry turbocharger turbine 1 and the power turbine 2, such that the turbo-compound apparatus 100 can make use of the exhaust energy to the utmost extent.

As shown in FIG. 1, the compressor 300 is connected with the variable geometry turbocharger turbine 1 and driven by the variable geometry turbocharger turbine 1 to compress air entering into the compressor 300, i.e., the air enters into a volute of the compressor 300 through inlet thereof and a blade wheel within the compressor 300 compresses the air under the drive of the variable geometry turbocharger turbine 1.

The intercooler 400 is connected between the compressor 300 and the engine 200 to cool the compressed air and deliver the cooled air to the cylinder 240 of the engine 200. In other words, the air compressed by the compressor 300 first passes through the intercooler 400 to be cooled and the cooled air enters into the respective cylinder 240 through the intake manifold 220. Thus, by fitting the intercooler 400 to cool the air compressed by the compressor 300, temperature of the air can be decreased, such that density of the air entering into the cylinder 240 of the engine 200 is increased, thus greatly increasing power per liter of the engine 200 and improving the power performance of the engine 200.

As for the engine system 1000 according to embodiments of the present invention, it is equipped with a variable geometry turbocharger turbine 1 and a power turbine 2. It is possible to improve torque and reduce emission of the engine 200 at engine low speed condition by distributing more exhaust energy to the variable geometry turbocharger turbine 1. At engine high-speed conditions, it is possible to improve the fuel economy of the engine 200 by distributing more exhaust energy to the power turbine 2. The engine system 1000 can make full use of the exhaust energy from the engine 200 at all operation conditions, thus improving the power performance and torque output of the engine 200, improving the fuel economy, reducing the exhaust gas emission and facilitating an environmental protection.

In an embodiment, the compressor 300 may be connected with the variable geometry turbocharger turbine 1 coaxially. The power turbine 2 is connected with the crankshaft 210 of the engine 200 via a hydraulic coupler 3. In other words, the hydraulic coupler 3 has an input shaft connected with the power turbine 2 and an output shaft connected with the crankshaft 210 of the engine 200 so as to transfer the mechanical work of the power turbine 200 to the crankshaft 210.

Alternatively, the engine system 1000 further includes a first transmission assembly 4 and a second transmission assembly 5, in which the first transmission assembly 4 is connected between the input shaft of the hydraulic coupler 3 and the power turbine 2, and the second transmission assembly 5 is connected between the output shaft of the hydraulic coupler 3 and the crankshaft 210.

Alternatively, the first transmission assembly 4 and the second transmission assembly 5 are one-stage gear transmission assemblies respectively. Certainly, the present invention is not limited to this. In other embodiments, the first transmission assembly 4 and the second transmission assembly 5 may be two-stage gear transmission assemblies or three-stage gear transmission assemblies respectively, or the first transmission assembly 4 is the one-stage gear transmission assembly and the second transmission assembly 5 is the two-stage gear transmission assembly, i.e., deceleration degrees of reduction transmission mechanisms of the first transmission assembly 4 and the second transmission assembly 5 can be changed according to the actual operation condition to adapt to different vehicles.

An operating process of the engine system 1000 according to embodiments of the present invention will be simply described in the following with reference to FIGS. 1-5.

First, for example, when the engine 200 works at the high-speed condition, the exhaust gas discharged from the engine 200 passes through the exhaust manifold 230 and the variable geometry turbocharger turbine 1, and the actuator controls the adjustable mechanism 11 to enlarge the opening degree of the guiding device 111 so as to reduce the expansion ratio of the variable geometry turbocharger turbine 1 and increase the proportion of the exhaust energy distributed to the power turbine 2. Moreover, the exhaust gas drives the variable geometry turbocharger turbine 1 to rotate so as to drive the compressor 300 to compress the air, and the compressed air enters into the cylinder 240 after being cooled by the intercooler 400. Simultaneously, the exhaust gas passing through the variable geometry turbocharger turbine 1 enters into the power turbine 2 to drive the power turbine 2 to work, and the exhaust energy recovered by the power turbine 2 is transferred to the crankshaft 210 in a form of the mechanical work. Thus, on one hand, the power of the variable geometry turbocharger turbine 1 is reduced reasonably to avoid the damage on the engine 200 due to the overcharging; on the other hand, the power output of the power turbine 2 is increased, thus improving a total power and the fuel economy of the engine 200.

For example, when the engine 200 works at the low-speed condition, the actuator controls the adjustable mechanism 11 to decrease the opening degree of the guiding device 111 so as to increase the expansion ratio of the variable geometry turbocharger turbine 1 and reduce the proportion of the exhaust energy distributed to the power turbine 2. Thus, on one hand, the power of the variable geometry turbocharger turbine 1 is effectively improved; on the other hand, the power proportion of the power turbine 2 is reduced, and the torque output and the drivability of the engine 200 at the low-speed condition are improved. The rest of the operation processes of the engine 200 at the low-speed condition are the same as those at the high-speed condition and will not be illustrated in detail herein.

In other words, in all the operation conditions of the engine 200, the guiding device 111 has an optimal opening degree to determine the exhaust energy distribution between the variable geometry turbocharger turbine 1 and the power turbine 2 corresponding to a specific operation condition, such that the turbo-compound apparatus 100 can make use of the exhaust energy to the utmost extent.

With the engine system 1000 according to embodiments of the present invention, it is possible to improve the output torque and the power performance of the engine 200 and increase the fuel economy of the engine 200 by adjusting the exhaust energy distribution between the variable geometry turbocharger turbine 1 and the power turbine 2 according to the actual operation condition of the engine 200. , Simultaneously, it is also possible to reduce the harmful gas emission to protect the environment, and make full use of the exhaust energy to improve the turbocharging efficiency and the recovery exhaust energy, thus greatly improving the performance of the engine 200 at all the operation conditions.

Other components (e.g., a lubrication system, a fuel supply system, etc.) of the engine system according to embodiments of the present invention as well as the operations thereof are known to those skilled in the area, so the detailed description thereof will be omitted here.

Reference throughout this specification to “an embodiment,” “some embodiments,” “one embodiment”, “another example,” “an example,” “a specific example,” or “some examples,” means that a particular feature, structure, material, or characteristic described in connection with the embodiment or example is included in at least one embodiment or example of the present invention. Thus, the appearances of the phrases such as “in some embodiments,” “in one embodiment”, “in an embodiment”, “in another example,” “in an example,” “in a specific example,” or “in some examples,” in various places throughout this specification are not necessarily referring to the same embodiment or example of the present invention. Furthermore, the particular features, structures, materials, or characteristics may be combined in any suitable manner in one or more embodiments or examples.

Although explanatory embodiments have been shown and described, it would be appreciated by those skilled in the art that the above embodiments cannot be construed to limit the present invention, and changes, alternatives, and modifications can be made in the embodiments without departing from spirit, principles and scope of the present invention.

What is claimed is:

1. A turbo-compound apparatus which has a variable geometry turbocharger turbine and is used to recover energy from an exhaust of an engine, the turbo-compound apparatus comprising:
the variable geometry turbocharger turbine connected with an exhaust manifold of the engine and having an adjustable mechanism to regulate the exhaust energy distribution;
a power turbine fitted downstream of the variable geometry turbocharger turbine and driven by exhaust gas passing through the variable geometry turbocharger turbine, an output end of the power turbine connected with a crankshaft of the engine to transfer mechanical work output from the power turbine to the crankshaft; and
an actuator configured to control the adjustable mechanism to operate according to actual operation conditions of the engine to regulate exhaust energy distribution between the variable geometry turbocharger turbine and the power turbine.

2. The turbo-compound apparatus according to claim 1, wherein the adjustable mechanism comprises a guiding device fitted upstream blades of the variable geometry turbocharger turbine and provided with variable opening degrees, and the guiding device is configured so as to continuously change the opening degree according to the actual operation condition of the engine to regulate the exhaust energy distribution between the variable geometry turbocharger turbine and the power turbine.

3. An engine system, comprising:
an engine comprising a crankshaft, an intake manifold and an exhaust manifold for discharging an exhaust gas;
a turbo-compound apparatus, which has a variable geometry turbocharger turbine and is used to recover energy from an exhaust of an engine, the turbo-compound apparatus comprising:
the variable geometry turbocharger turbine connected with an exhaust manifold of the engine and having an adjustable mechanism to regulate the exhaust energy distribution;
a power turbine fitted downstream of the variable geometry turbocharger turbine and driven by exhaust gas passing through the variable geometry turbocharger turbine, an output end of the power turbine connected with a crankshaft of the engine to transfer mechanical work output from the power turbine to the crankshaft; and
an actuator configured to control the adjustable mechanism to operate according to actual operation conditions of the engine to regulate exhaust energy distribution between the variable geometry turbocharger turbine and the power turbine, the variable geometry turbocharger turbine being fitted downstream of the exhaust manifold of the engine to receive the exhaust gas discharged from the engine;
a compressor connected with the variable geometry turbocharger turbine and driven by the variable geometry turbocharger turbine to compress air entering into the compressor; and
an intercooler connected between the compressor and a cylinder of the engine to cool the compressed air and deliver the cooled air to the cylinder of the engine.

4. The engine system according to claim 3, wherein the compressor is connected with the variable geometry turbocharger turbine coaxially.

5. The engine system according to claim 3, further comprising:
a hydraulic coupler having an input shaft connected with the power turbine and an output shaft connected with the crankshaft of the engine so as to transfer the mechanical work of the power turbine to the crankshaft.

6. The engine system according to claim 5, further comprising:
a first transmission assembly connected between the input shaft of the hydraulic coupler and the power turbine.

7. The engine system according to claim 6, further comprising:
a second transmission assembly connected between the output shaft of the hydraulic coupler and the crankshaft.

8. The engine system according to claim 7, wherein the first transmission assembly and the second transmission assembly are one-stage gear transmission assemblies respectively.

9. The engine system according to claim 3, wherein the adjustable mechanism comprises a guiding device fitted upstream blades of the variable geometry turbocharger turbine and provided with variable opening degrees, and the guiding device is configured so as to continuously change the opening degree according to the actual operation condition of the engine to regulate the exhaust energy distribution between the variable geometry turbocharger turbine and the power turbine.
